(19) United States
(12) Patent Application Publication
(10) Pub. No.: US 2003/0196554 A1
(43) Pub. Date: Oct. 23, 2003

(54) Dual mode hot beverage dispenser

(76) Inventors: Steve L. Koontz, Black Canyon City, AZ (US); Stuart P. Kaner, Phoenix, AZ (US)

Correspondence Address: CAHILL, SUTTON & THOMAS P.L.C., Attn: Marvin A. Glazer, 155 Park One, 2141 East Highland Avenue, Phoenix, AZ, 85016, US

(21) Appl. No.: 10/126,824

(22) Filed: Apr. 19, 2002

(51) Int. Cl. A23F 3/00

(52) U.S. Cl. 99/323.3

(57) ABSTRACT

A dual mode liquid concentrate beverage dispenser includes both a pour-over water inlet and a plumbed water line inlet, either of which may be used to provide water to a heating tank. The pour-over water inlet is used to add water to the dispenser when located remote from a plumbed water supply line. A dump valve selectively supplies heated water to a mixing chamber. A concentrate pump selectively moves concentrated liquid beverage from a source thereof to the mixing chamber. The mixing chamber dilutes the beverage concentrate with heated water to provide an individual serving of a desired hot beverage.

### BACKGROUND OF THE INVENTION

1. Field of the Invention

The present invention relates generally to dispensers for preparing and dispensing hot beverages such as coffee, hot chocolate, and the like, and more particularly, to an improved dual mode dispenser adapted to operate off of a plumbed water supply line or in a pour over mode.

2. Description of the Relevant Art

Office, factories, and even restaurants often supply hot beverages, like coffee or hot chocolate, for employees and/or patrons. Ideally, such beverages are produced almost instantaneously upon demand, thereby allowing employees to get back to their jobs quickly, and avoiding the need for patrons to wait for significant delay times. In practice, some offices and establishments use relatively low volume equipment, such as coffee brewers that must be refilled with water for each new batch of coffee; users of these low volume systems must wait for each brewing cycle to be completed before the coffee or other beverage is ready to be served. Moreover, coffee and other brewed beverages often require that filters be discarded and replaced, that coffee grounds be measured out, and that serving carafes be cleansed, for each batch of coffee that is made. These steps all require additional employee time. Of course, large demands for such beverages can be satisfied by producing larger quantities of such beverages, but that approach often results in significant waste, as the prepared beverage can quickly get stale after being kept on a warming element, and any beverage remaining at the end of a work day must typically be discarded.

It is known in the art of beverage dispensing technology to use so-called shelf-stable, “bag-in-a-box” concentrated products to produce hot beverages in individual portions to avoid wastage, and to avoid the necessity of dealing with filters or carafes. For example, The Douwe Egberts Coffee Systems division of the Sara Lee Corporation in Itasca, Ill., supplies a frozen coffee concentrate packaged in an inner deformable bag that is, in turn, packaged in a cardboard outer box under the trademark “Douwe Egberts”. The same company supplies dispensers which mix such coffee concentrate with heated water to dispense a final coffee product. Such “bag-in-the-box” beverage concentrates, along with their related dispensers, allow for high volume production of coffee or other hot beverages with little waste, and without the mess or bother of filter baskets, coffee grounds or carafes.

Unfortunately, dispensers for use with such “bag-in-the-box” beverage concentrates typically require access to a plumbed water service line connected to the municipal water supply. However, in some offices, or at least in portions of some offices, there is no plumbed water line available. In that case, such “bag-in-the-box” beverage concentrate dispensers either can not be used at all, or they must be located somewhere remote from the location where the beverage will be consumed.

Accordingly, it is an object of the present invention to provide a hot beverage dispenser capable of producing beverages almost instantaneously upon demand, without requiring a waiting period during a brewing cycle.

Another object of the present invention is to provide such a hot beverage dispenser which avoids the requirement for handling of coffee filters, coffee grounds, powders, granules, or serving carafes in order to produce the beverage.

Still another object of the present invention is to provide such a dispenser which avoids wasted beverage due to the beverage becoming stale and/or due to the failure to consume all of the prepared beverage at the end of each shift or work day.

A further object of the present invention is to provide such a dispenser that can be positioned proximate to where the beverage will be consumed, even if there is no plumbed water line available.

These and other objects of the present invention will become more apparent to those skilled in the art as the description of the present invention proceeds.

### SUMMARY OF THE INVENTION

Briefly described, and in accordance with a preferred embodiment thereof, the present invention relates to an apparatus for dispensing a hot beverage, and including a water inlet basin adapted to receive poured water, and a heating tank coupled to the water inlet basin for receiving water therefrom. The heating tank includes a heating element for heating the water therein, as well as a water outlet for supplying heated water. In the preferred embodiment, a water level sensor detects whether water within the water inlet basin is below a predetermined level, and if so, a visual indicator is activated to indicate that more water should be added to the water inlet basin.

The apparatus also includes a concentrate pump that includes a pump inlet adapted to be coupled to a source of beverage concentrate, such as a shelf-stable liquid coffee concentrate, chocolate concentrate, or the like. The concentrate pump includes a pump outlet, and the concentrate pump selectively forces beverage concentrate from the pump inlet to the pump outlet. The dispenser also includes a water valve having an inlet coupled to the water outlet of the heating tank for receiving heated water; the valve selectively permitting the heated water to exit from a valve outlet. The dispenser further includes a mixing chamber coupled to the pump outlet for receiving the highly-concentrated form of the desired beverage, and coupled to the valve outlet for receiving heated water. The dispenser also includes a mixing chamber coupled to the pump outlet and to the valve outlet for diluting the beverage concentrate with heated water. When the beverage is to be dispensed, the concentrate pump and water valve are actuated to send beverage concentrate and hot water to the mixing chamber to provide the desired hot beverage. The mixing chamber preferably includes an outlet dispenser for dispensing the hot beverage directly into a cup.

The concentrate pump is preferably a peristaltic pump that includes an electric motor that rotates a plurality of rollers for engaging a flexible tube. The water valve is preferably an electrically-actuated dump valve that selectively allows water to flow under the force of gravity therethrough. A user preferably operates the concentrate pump and water valve simultaneously by depressing a switch.

A second aspect of the present invention relates to a dual-inlet mode dispensing apparatus adapted to receive either poured water, in the manner described above, or water from a plumbed water supply line, in order to permit the user to locate remote from, or proximate to, a plumbed water supply. In this instance, the apparatus includes both a first water inlet adapted to receive water from a plumbed municipal water supply line, as well as a second water inlet, e.g., an opening located above the previously described water inlet basin, adapted to receive poured water. In the preferred embodiment, the first water inlet adapted to receive municipal water, and the second water inlet adapted to receive poured water, both provide water to a common water inlet basin.

The dual-mode apparatus again includes a heating tank having a heating element as described above. The heating tank receives water supplied by either the first water inlet or the second water inlet, as by way of the aforementioned water inlet basin, and supplies heated water at its water outlet. As described above, the apparatus also includes a concentrate pump and a water valve for selectively providing liquid beverage concentrate and heated water, respectively, to a mixing chamber for diluting the beverage concentrate with heated water.

In this dual-mode apparatus, a water inlet valve is preferably inserted between the first water inlet and the plumbed municipal water supply line for selectively supplying municipal water to the first water inlet. This water inlet valve preferably includes an electrically-actuated solenoid. The dispenser apparatus may include a selector switch for allowing a user to disable the electrically-actuated solenoid in the event that the first water inlet is not coupled to a plumbed municipal water supply line.

### BRIEF DESCRIPTION OF THE DRAWINGS

FIG. 1 is a frontal view of a dispensing apparatus constructed in accordance with a preferred embodiment of the present invention, and showing a peristaltic pump, mixing chamber, and outlet dispenser.

FIG. 2 is an exposed side view of the dispensing apparatus shown in FIG. 1, and showing the locations of a water inlet basin, solenoid-controlled water inlet valve, heating tank, and dump valve.

FIG. 3 is a top view of the dispensing apparatus shown in FIGS. 1 and 2 and illustrating a water inlet port for receiving poured water, water inlet basin, heating tank, and hot water dump valve.

FIG. 4 is a perspective, cut-away view of the heating tank, including heating element, thermostat, and dump valve.

FIG. 5 is a perspective view of the water inlet basin, including dual float valve sensors.

FIG. 6 is a perspective view of the mixing chamber that mixes pumped beverage concentrate with heated water.

FIG. 7 is an electrical schematic of the circuitry used to operate the preferred embodiment of the present invention.

### DETAILED DESCRIPTION OF THE PREFERRED EMBODIMENT

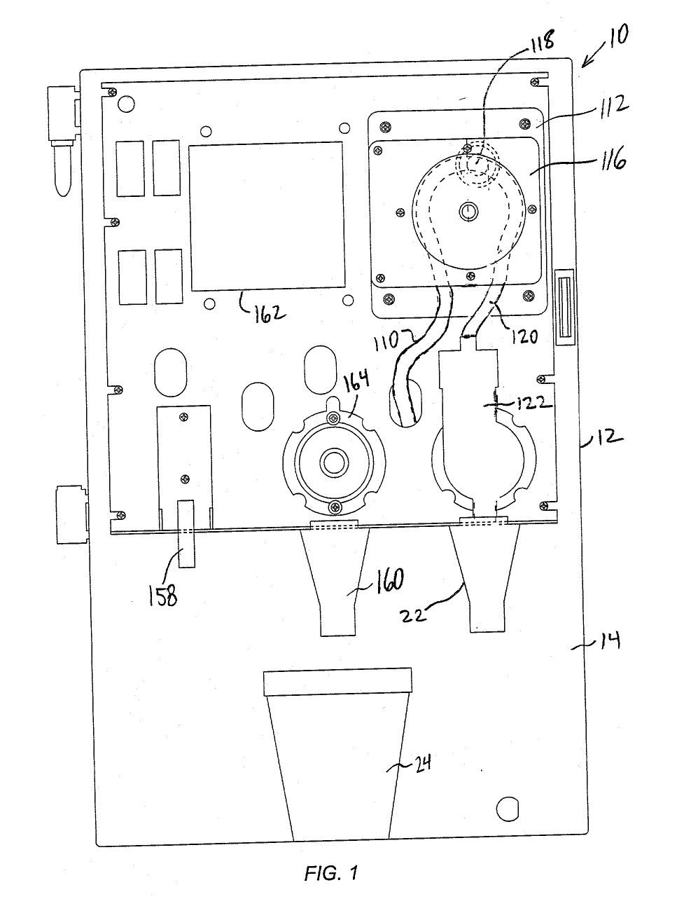

With reference to FIGS. 1-3, a hot beverage dispensing apparatus constructed in accordance with a preferred embodiment of the present invention is designated generally by reference numeral 10. Dispenser 10 includes a steel outer housing 12, including a front wall 14, rear wall 16, and opposing side walls 18 and 20. Projecting from front wall 14 are one or more nozzles 22 for dispensing a selected hot beverage into a user's cup 24. If desired, the upper portion of the front wall 14 can be covered by a hinged door to hide the working components from view.

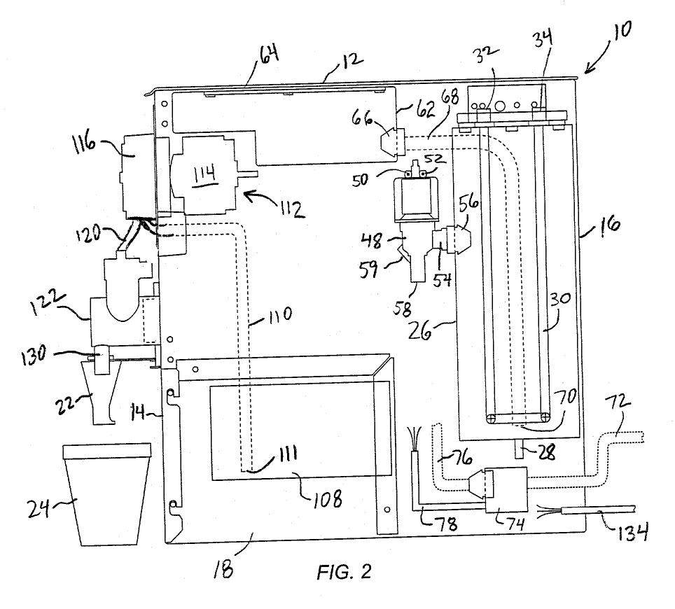

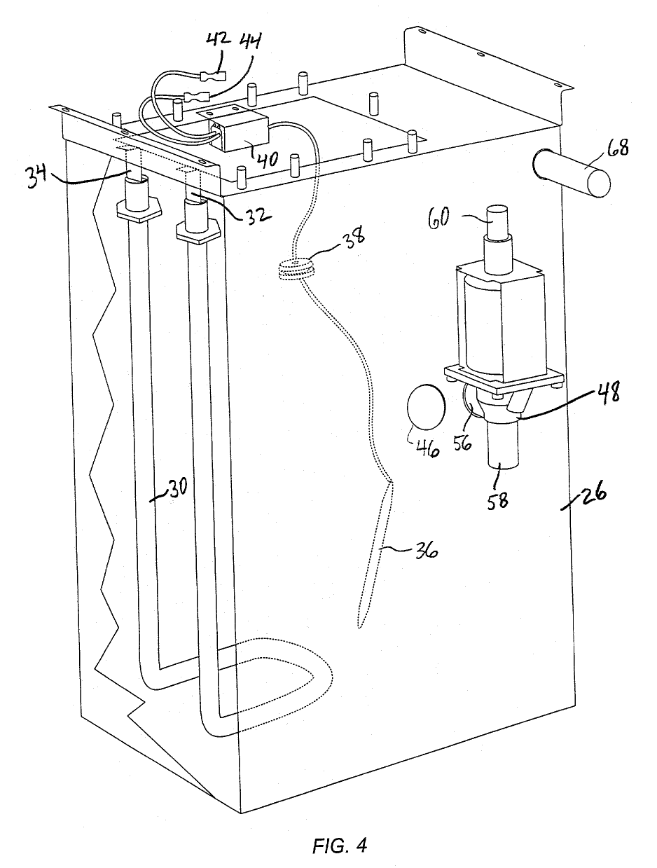

As mentioned above, the hot beverage dispensing apparatus of the present invention mixes a liquid beverage concentrate with heated water. Accordingly, a hot water tank 26 is provided within outer housing 12 adjacent rear wall 16 thereof. Hot water tank, or heating tank, 26 is preferably made of steel. As shown in FIG. 2, heating tank 26 may include a lowermost drain nipple 28, which is normally plugged closed, but which may be opened to drain heating tank 26 when maintenance is being performed. A resistance-type heating element 30 extends downwardly into heating tank 26. Heating element 30 is preferably a 1400 Watt immersion heater coil includes two electrical terminals 32 and 34 at its opposing upper ends for allowing electrical current to be passed therethrough. Referring to FIG. 4, a thermal sensing element 36, such as a thermocouple, also extends within heating tank 26 for sensing the temperature of the water therein. Thermocouple 36 may be supported, in part, by a rubber grommet 38 adapted to engage a cover plate (not shown) that closes the top opening of heating tank 26. Thermocouple 36 is coupled to a thermostat 40, which is preferably of the type commercially available from the White-Rodgers division of Emerson Electric Co. in St. Louis, Mo. under Part No. 2B61-458. This thermostat includes an adjustment knob that can be used to set the temperature; under ordinary circumstances, thermostat 40 is set to maintain a hot water temperature of between 185-190 degrees Fahrenheit. Thermostat 40 includes a pair of electrical leads 42 and 44; thermostat 40 is electrically coupled in series with heating element 30 to regulate the flow of electrical power therethrough.

Heating tank 26 includes one or more water outlet openings formed in the front side wall thereof. Referring to FIG. 4, aperture 46 represents one such water outlet opening, while a second water outlet opening is shown covered by a dump valve 48. Dump valve 48 is preferably of the type commercially available from Deltrol Controls of Milwaukee, Wis. under Part No. 70018-60. This low pressure liquid dispensing valve is normally closed when electrical power is turned off. Dump valve 48 includes an electrically-activated coil/plunger assembly which selectively lifts a spring-loaded diaphragm. When electrically energized, heated water flows under the force of gravity through dump valve 48 from heating tank 26. A pair of electrical terminals 50 and 52 (see FIG. 2) extend from the solenoid assembly of dump valve 48 for receiving an alternating current voltage to selectively open the valve. The inlet port 54 of dump valve 48 is sealingly secured to an aperture in heating tank 26 by a flexible grommet 56. The outlet port 58 of dump valve 48 extends downwardly therefrom; channel 59 communicates with outlet port 58 and serves as an air vent. An adjustment screw 60 extends upwardly from the solenoid assembly of dump valve 48; rotation of adjustment screw 60 varies the flow rate through dump valve 48 when the valve is opened. This feature may be used vary the dilution ratio of hot water relative to liquid beverage concentrate.

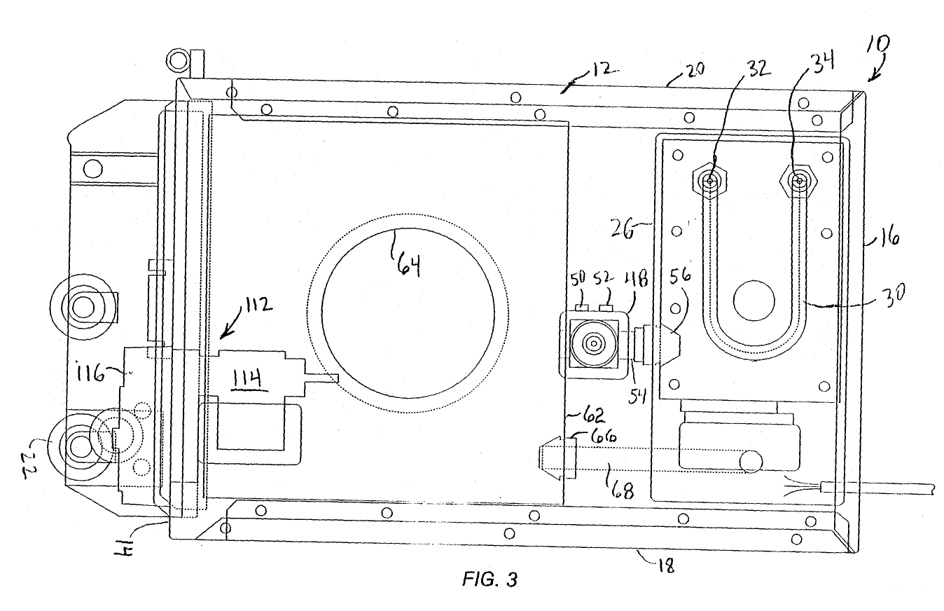

Of course, before one can heat water within heating tank 26, one must first introduce water into heating tank 26. As shown in FIGS. 2 and 3, dispensing apparatus 10 includes a water inlet basin 62 located in the upper region of housing 12 in front of heating tank 26. Water inlet basin 62 is preferably made of stainless steel and is adapted to receive poured water that an operator pours from a handheld container through opening 64 in the upper wall of outer housing 12. An opening is formed in the lower region of basin 62 for receiving a flexible grommet 66. In turn, grommet 66 receives an upper end of a steel water delivery tube 68 that extends into heating tank 26; the lowermost end 70 of steel tube 66 lies adjacent the bottom of heating tank 26. In this manner, fresh cold water flows from inlet basin 62 into heating tank 26. The lowermost end 70 of steel tube 68 is somewhat isolated from water outlet aperture 46, and from dump valve 48; accordingly, fresh cold water can not reach the water outlet ports directly.

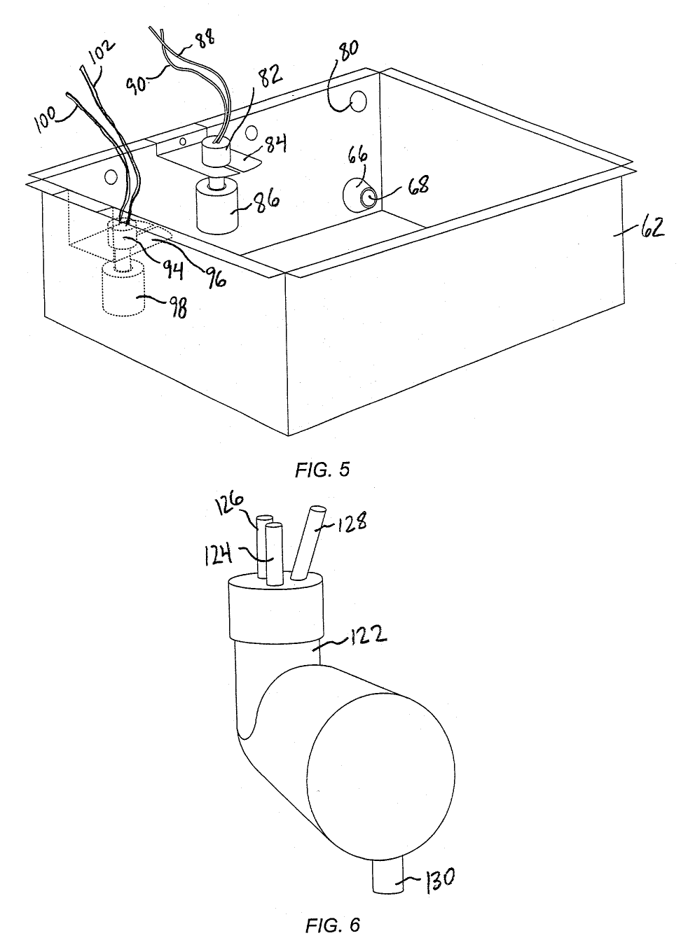

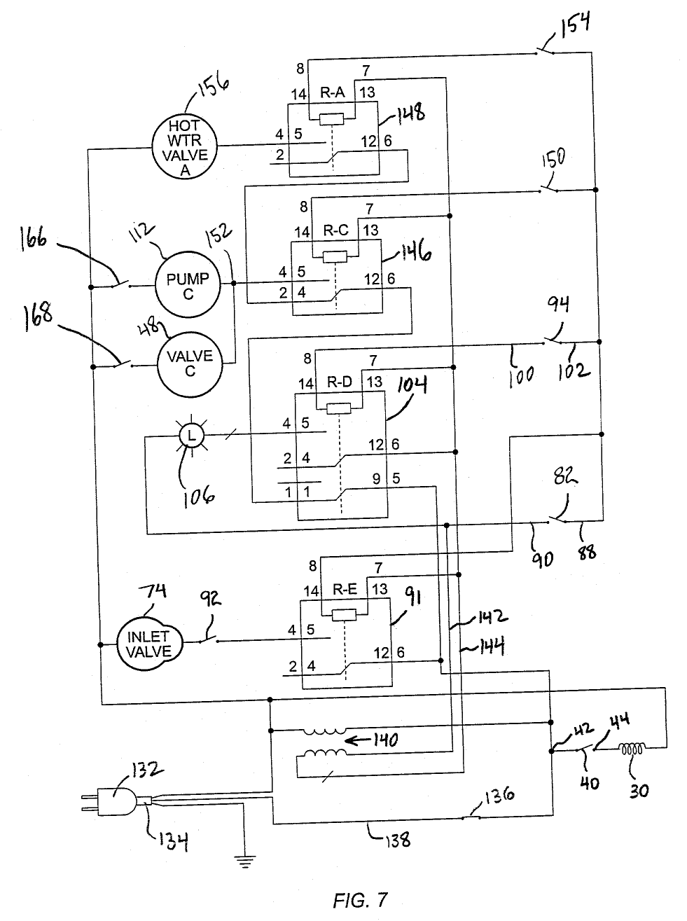

As mentioned above, one aspect of the present invention relates to the ability to introduce fresh water into the dispensing apparatus either by the pour-over method described above, or by connection to a plumbed line. In FIG. 2, water inlet tube 72 is connected to a plumbed municipal supply water line. Water inlet tube 72 is coupled inside housing 12 to a solenoid-controlled inlet valve 74, which is of the type that is closed unless energized by application of a control voltage to the solenoid. The outlet of inlet valve 74 is coupled to one end of a water supply tube 76. Wiring cable 78 extends from the solenoid of inlet valve 74 to control circuitry that is described in greater detail below in conjunction with FIG. 7. The opposing end (not shown) of water supply tube 76 extends through aperture 80 of water inlet basin 62 (see FIG. 5) for allowing water to flow into basin 62 whenever inlet valve 74 is open. The solenoid of inlet valve 74 is controlled under the operation of a water level sensor 82 which is supported in the upper portion of inlet basin 62 by bracket 84. Sensor 82 includes a float 86 which rises up to bracket 84 when inlet basin 62 is filled with water, but which falls below bracket 84 as water is drained from inlet basin 62. A pair of electrical leads 88 and 90 extend from sensor 82. When float 86 falls, electrical leads 88 and 90 trigger a relay 91 (see the schematic of FIG. 7) that energizes the solenoid of inlet valve 74 to permit fresh water to flow into inlet basin 62. Conversely, when float 86 rises, the solenoid of inlet valve 74 is de-energized, and the flow of fresh water into inlet basin 62 ceases.

If dispensing apparatus 10 is located remote from a plumbed water supply line, then water inlet valve 74 is not used, and water is added solely via the pour-over method described above. An electrical selector switch 92 (see the schematic of FIG. 7) is coupled in series with the solenoid of water inlet valve 74 to selectively disable inlet valve 74 when no plumbed water supply line is available. Electrical switch 92 can be provided in the form of a rocker switch located in the rear portion of outer housing 12. When operating in the pour-over mode, users need to be warned when it is time to add more water to water inlet basin 62; otherwise, heating tank 26 would eventually run out of water. Accordingly, a second water level sensor 94 is supported by bracket 96 within inlet basin 62 at a somewhat lesser height than bracket 84 and sensor 82. Sensor 94 includes a float 98 which rises up to bracket 96 when inlet basin 62 is nearly filled with water, but which falls below bracket 96 as water is drained from inlet basin 62. A pair of electrical leads 100 and 102 extend from sensor 94. When float 98 falls, electrical leads 100 and 102 trigger a relay 104 that energizes a warning light 106 (see the schematic of FIG. 7) to remind a user to add water to inlet basin 62 by pouring fresh water into opening 64 in the upper wall of outer housing 12. Warning light 106 might be physically located on the door that normally covers the upper front portion of the dispensing apparatus. Conversely, when float 98 rises due to the addition of water into inlet basin 62, relay 104 is de-energized, and warning light 106 is extinguished.

As described above, the hot beverage to be dispensed is prepared by mixing heated water with a room-temperature beverage liquid concentrate. As shown in FIG. 2, a box 108 holding the liquid concentrate beverage product can be stored behind front wall 14, if desired. Box 108 contains a flexible bag (not shown) which actually contains the liquid concentrate beverage product; the flexible bag can deform as the liquid concentrate beverage product is dispensed therefrom. The beverage concentrate might be a shelf-stable liquid coffee concentrate, or perhaps a shelf-stable liquid chocolate concentrate, and typically needs to be diluted in the ratio of one part concentrate to thirty parts hot water, though other ratios may also be used. As mentioned above, dump valve 48 includes an adjustment mechanism which can be used to vary the amount of hot water that is mixed with a given amount of beverage concentrate. Beverage concentrate is pumped from such flexible bag through a flexible tube 110 using a peristaltic pump 112. A first end 111 of flexible tube 110, which serves as the pump inlet, is inserted into the flexible bag containing the beverage concentrate. Peristaltic pump 112 includes an electric motor 114 (see FIG. 2), as well as a tube-receiving housing 116. Motor 114 causes a set of three rollers, arranged in a triangular pattern, to rotate inside tube receiving housing 116. One of such rollers is indicated in dashed outline in FIG. 1 by reference numeral 118. Flexible tube 110 is inserted into the bottom of tube-receiving housing 116, loops around in an inverted-U shape, and exits from the bottom of tube-receiving housing 116. Motor 114 causes the three rollers (of which 118 is one example) to rotate in a clockwise direction, relative to FIG. 1; at least one of such rollers is always compressing flexible tube 110 between the roller and the surrounding tube-receiving housing 116. As a result, beverage concentrate is pumped through tube 110 from first end 111 within box 108, upwardly into the left side of tube-receiving housing 116, and back down the right side of tube-receiving housing 116, relative to FIG. 1, through tube portion 120, which serves as the pump outlet.

In the preferred embodiment, peristaltic pump 112 is of the type commercially available from Anko Products, Inc. of Bradenton, Fla. under the trademark MityFlex®, Part No. 800-101-5080. Flexible tube 110 has an inner diameter of one-eighth inch, and the rollers within peristaltic pump 112 rotate at the rate of 75 RPM; as a result, beverage concentrate is pumped at the rate of approximately 10.5 milliliters for every ten seconds. At the same time, dump valve 48 is designed to dump approximately 315 milliliters of hot water in ten seconds. Thus, in a ten second period, a total of 325 milliliters of liquid (approximately 10 fluid ounces) is dispensed.

Dispensing apparatus 10 also includes a mixing chamber 122 for mixing together the hot water and beverage concentrate before dispensing the same. Mixing chamber 122 includes a first port 124 coupled to the pump outlet tube portion 120 for receiving pumped beverage concentrate. Mixing chamber 122 also includes a second port 126 coupled by a flexible tube (not shown) to the outlet 58 of dump valve 48 for receiving dumped hot water. Mixing chamber 122 also includes a third port 128 which serves as an air vent to facilitate the mixing process. Mixing chamber 122 dilutes the beverage concentrate with heated water to provide the desired hot beverage at output port 130, which is connected to outlet dispenser 22 for dispensing the hot beverage directly into cup 24.

Referring now to FIG. 7, grounded electrical plug 132 bring 110 Volt A.C. electrical power into dispensing apparatus 10 via power cord 134. For safety purposes, a normally-closed bimetallic safety thermostat 136, physically mounted at the top of heating tank 126, is inserted in series with power lead 138 to disable power if the heating tank gets overheated. Thermostat 40 selectively permits electrical current to flow through immersion coil 30 to maintain water in heating tank 26 at the desired temperature.

Transformer 140 converts the original 110 Volt A.C. power into a 12 Volt A.C. voltage across conductors 142 and 144. This 12 Volt A.C. voltage is used to operate water level sensors 82 and 94, as well as the low-voltage trigger input sides of relays 146 and 148. Switch 150 is depressed by a user in order to dispense a hot beverage. When switch 150 is depressed, relay 146 applies 110 Volt A.C. power to node 152 for energizing both the electric motor (114) of peristaltic pump 112 and hot water dump valve 48; both pump 112 and dump valve 48 allow beverage concentrate and hot water to flow, respectively, for so long as the user depresses switch 150. In an alternate embodiment, depression of switch 150 activates a ten second timer which automatically operates relay 146 for ten seconds to dispense 10 fluid ounces of the hot beverage.

Switch 154 may be used to operate relay 148 to open a second dump valve 156 for allowing hot water to be dispensed from a separate dispenser nozzle in the event that a user wishes only hot water to be dispensed. Referring briefly to FIG. 1, port 158 can be connected by a flexible tube to the outlet of second dump valve 156 for dispensing hot water into a user's cup when switch 154 is depressed. Both switches 150 and 154 may be located on the hinged door that normally covers the upper half of the front wall 14 of outer housing 12.

Again referring to FIG. 1, those skilled in the art will note that dispensing nozzle 160 is also provided in the event that dispensing apparatus is to dispense more than just one hot beverage. For example, nozzle 22 can be used to dispense coffee, while nozzle 160 can be used to dispense hot chocolate. In this case, a second peristaltic pump (not shown) is installed in opening 162, and a second shelf-stable container of beverage concentrate is provided at the inlet to such second peristaltic pump. Likewise, an additional hot water dump valve is secured to the side of heating tank 26 for selectively directing heated water to a second mixing chamber (not shown) that is secured over bracket 164.

Switches 166 and 168 (see FIG. 7) are normally closed, but are provided to facilitate cleaning of the dispensing apparatus and/or maintenance thereof. For example, if switch 166 is opened, then depression of switch 150 will cause hot water to be supplied to mixing chamber 122, but no beverage concentrate will be pumped; mixing chamber 122 can then be thoroughly cleaned of any beverage concentrate residue. Alternatively, if switch 168 is opened, then depression of switch 150 will cause beverage concentrate to be supplied at full strength, without being diluted by hot water; this allows one to measure the amount of beverage concentrate being dispensed in order to confirm that the amount of such concentrate being pumped during each dispensing cycle is, in fact, the desired amount.

Those skilled in the art will now appreciate that an improved dispensing apparatus has been described which is capable of producing hot beverages almost instantaneously upon demand, without requiring a waiting period during a brewing cycle, while avoiding the requirement for handling of coffee filters, coffee grounds, powders, granules, or serving carafes in order to produce the beverage. The disclosed apparatus also avoids waste because the prepared beverage does not become stale, and only the amount of beverage that is actually being consumed is prepared. Moreover, the disclosed beverage dispenser can be positioned at the point where the beverage will be consumed, whether or not there is a plumbed water line available. While the present invention has been described with respect to preferred embodiments thereof, such description is for illustrative purposes only, and is not to be construed as limiting the scope of the invention. Various modifications and changes may be made to the described embodiments by those skilled in the art without departing from the true spirit and scope of the invention as defined by the appended claims.

I claim:

1. An apparatus for dispensing a hot beverage, including in combination:
a. a water inlet basin adapted to receive poured water;
b. a heating tank including a heating element, the heating tank being coupled to the water inlet basin for receiving water therefrom, the heating tank including a water outlet for supplying heated water;
c. a pump having a pump inlet coupled to a source of beverage concentrate and including a pump outlet, the pump selectively forcing beverage concentrate from the pump inlet to the pump outlet;
d. a valve having a valve inlet coupled to the water outlet of the heating tank for receiving heated water, the valve including a valve outlet; and
e. a mixing chamber coupled to the pump outlet for receiving beverage concentrate, and coupled to the valve for receiving heated water, the mixing chamber diluting the beverage concentrate with heated water to provide a desired hot beverage.

2. The apparatus recited by claim 1 wherein the pump inlet is coupled to a source of a shelf-stable liquid coffee concentrate.

3. The apparatus recited by claim 1 wherein the pump inlet is coupled to a source of a shelf-stable liquid chocolate concentrate.

4. The apparatus recited by claim 1 wherein the mixing chamber includes an outlet dispenser for dispensing the hot beverage directly into a cup.

5. The apparatus recited by claim 1 wherein the pump is a peristaltic pump that includes an electric motor which rotates a plurality of rollers for engaging a flexible tube to move liquid through the flexible tube.

6. The apparatus recited by claim 5 wherein the valve is an electrically-actuated dump valve that selectively allows water to flow under the force of gravity therethrough.

7. The apparatus recited by claim 6 wherein the dump valve is adjustable to vary the flow rate therethrough when the dump valve is electrically-actuated.

8. The apparatus recited by claim 6 including a switch operated by a user to dispense the desired hot beverage, the electric motor of the peristaltic pump and the dump valve both being actuated when the user operates the switch.

9. The apparatus recited by claim 1 including:
a. a water level sensor for sensing whether water within the water inlet basin is below a predetermined level; and
b. a visual indicator electrically coupled to the water level sensor for indicating to a user that water should be added to the water inlet basin via the second water inlet.

10. An apparatus for dispensing a hot beverage, including in combination:
a. a first water inlet adapted to receive water from a plumbed municipal water supply line;
b. a second water inlet adapted to receive poured water in the event that the first water inlet is not coupled to a plumbed municipal water supply line;
c. a heating tank including a heating element, the heating tank being coupled to the first water inlet and to the second water inlet for receiving water therefrom, the heating tank including a water outlet for supplying heated water;
d. a pump having a pump inlet coupled to a source of beverage concentrate and including a pump outlet, the pump selectively forcing beverage concentrate from the pump inlet to the pump outlet;
e. a valve having a valve inlet coupled to the water outlet of the heating tank for receiving heated water, the valve including a valve outlet; and
f. a mixing chamber coupled to the pump outlet for receiving beverage concentrate, and coupled to the valve for receiving heated water, the mixing chamber diluting the beverage concentrate with heated water to provide a desired hot beverage.

11. The apparatus recited in claim 10 including a water inlet valve coupled between the first water inlet and the heating tank for selectively supplying water to the heating tank.

12. The apparatus recited in claim 11 wherein the water inlet valve includes an electrically-actuated solenoid.

13. The apparatus recited in claim 12 further including:
a. a water inlet basin disposed between the water inlet valve and the heating tank, the water inlet basin providing water to the heating tank;
b. a water level sensor for sensing whether water within the water inlet basin is below a predetermined level, the water level sensor being electrically-coupled to the electrically-actuated solenoid for selectively opening the water inlet valve.

14. The apparatus recited in claim 12 including a selector switch for allowing a user to disable the electrically-actuated solenoid in the event that the first water inlet is not coupled to a plumbed municipal water supply line.

15. The apparatus recited by claim 10 wherein the pump inlet is coupled to a source of a shelf-stable liquid coffee concentrate.

16. The apparatus recited by claim 10 wherein the pump inlet is coupled to a source of a shelf-stable liquid chocolate concentrate.

17. The apparatus recited by claim 10 wherein the mixing chamber includes an outlet dispenser for dispensing the hot beverage directly into a cup.

18. The apparatus recited by claim 10 wherein the pump is a peristaltic pump that includes an electric motor that rotates a plurality of rollers for engaging a flexible tube to move liquid through the flexible tube.

19. The apparatus recited by claim 18 wherein the valve is an electrically-actuated dump valve that selectively allows water to flow under the force of gravity therethrough.

20. The apparatus recited by claim 19 wherein the dump valve is adjustable to vary the flow rate therethrough when the dump valve is electrically-actuated.

21. The apparatus recited by claim 10 including a switch operated by a user to dispense the desired hot beverage, the electric motor of the peristaltic pump and the dump valve both being actuated when the user operates the switch.

22. The apparatus recited by claim 10 further including a water inlet basin disposed between the first water inlet and the heating tank, and disposed between the second water inlet and the heating tank, the water inlet basin providing water to the heating tank.

23. The apparatus recited by claim 22 including:
a. a water level sensor for sensing whether water within the water inlet basin is below a predetermined level; and
b. a visual indicator electrically coupled to the water level sensor for indicating to a user that water should be added to the water inlet basin via the second water inlet.
